(19) United States
(12) Patent Application Publication
(10) Pub. No.: US 2012/0170114 A1
(43) Pub. Date: Jul. 5, 2012

(54) METAMATERIAL FILTER

(75) Inventors: Lawrence H. Domash, Conway, MA (US); Daniel Wasserman, Lexington, MA (US)

(73) Assignee: TRITON SYSTEMS, INC., Chelmsford, MA (US)

(21) Appl. No.: 13/343,533

(22) Filed: Jan. 4, 2012

Related U.S. Application Data
(60) Provisional application No. 61/429,662, filed on Jan. 4, 2011.

(51) Int. Cl. G02B 5/28; F21V 9/04

(52) U.S. Cl. 359/359; 359/579

(57) ABSTRACT

Embodiments herein are directed to a metamaterial transmission filters including a metamaterial component and a upper medium positioned within proximity of the metamaterial component such that movement of the upper medium changes the resonances and optical transmission, reflection or absorption spectra of the filter. The upper material may be a natural material or a second metamaterial identical or non-identical to the metamaterial component. Embodiments herein are designed to allow both continuous tuning of the optical spectra of the assembly and/or discrete spectral switching.

### CROSS-REFERENCE TO RELATED APPLICATIONS

This application claims priority to U.S. Provisional Application No. 61/429,662 entitled “Metamaterial Filter” filed Jan. 4, 2011, which is herein incorporated by reference in its entirety.

### GOVERNMENT INTERESTS

Not applicable

### PARTIES TO A JOINT RESEARCH AGREEMENT

Not applicable

### INCORPORATION BY REFERENCE OF MATERIAL SUBMITTED ON A COMPACT DISC

Not applicable

### BACKGROUND

Not applicable

### SUMMARY

Embodiments are generally directed to an optical transmission filter including a first patterned metamaterial layer, a material layer electromagnetically coupled to the first patterned metamaterial layer, and one or more micromechanical actuator operably connecting the first patterned metamaterial layer and the second metamaterial layer, the one or more micromechanical actuator being capable of providing vertical actuation, lateral actuation, or combinations thereof of the first patterned metamaterial layer relative to the second metamaterial layer. In some embodiments, the material layer is a second patterned metamaterial layer, and each of the patterned metamaterial layer and the second patterned metamaterial layer may include a metal patterned on a substrate to produce an array of split ring resonators. In particular embodiments, the substrate may be diamond, GaAs, ZnS, Ge, SiGe, GaInP, AlGaAs, GaInAs, AlInGaP, GaAsN, GaN, GaInN, InN, GaInAlN, GaAlSb, GaInAlSb, CdTe, MgSe, MgS, 6HSiC, ZnTe, CgSe, GaAsSb, GaSb, InAsN, 4H—SiC, a-Sn, BN, BP, BAs, AlN, ZnO, ZnSe, CdSe, CdTe, HgS, HgSe, PbS, PbSe, PbTe, HgTe, HgCdTe, CdS, ZnSe, InSb, AlP, AlAs, AlSb, InAs, or AlSb, and in various embodiments, the patterned metamaterial layer and second patterned metamaterial layer are the same or different. In other embodiments, the material layer may be a natural material layer, such as, but not limited to, diamond, GaAs, ZnS, Ge, SiGe, GaInP, AlGaAs, GaInAs, AlInGaP, GaAsN, GaN, GaInN, InN, GaInAlN, GaAlSb, GaInAlSb, CdTe, MgSe, MgS, 6HSiC, ZnTe, CgSe, GaAsSb, GaSb, InAsN, 4H—SiC, a-Sn, BN, BP, BAs, AlN, ZnO, ZnSe, CdSe, CdTe, HgS, HgSe, PbS, PbSe, PbTe, HgTe, HgCdTe, CdS, ZnSe, InSb, AlP, AlAs, AlSb, InAs, or AlSb.

In certain embodiments, the material layer may include pillars configured and arranged to interact with components of a pattern on the metamaterial layer, and the material layer of such embodiments may be metamaterials or natural materials.

The patterned metamaterial layer and the material layer of various embodiments can be separated by a distance of from about 5 nm to about 5000 nm. In some embodiments, each micromechanical actuator can be configured to vertically change the distance between the patterned metamaterial layer and the material layer by about 5 nm to about 5000 nm, and on other embodiments, each micromechanical actuator can be configured to laterally change a position of the first patterned metamaterial layer relative to the material layer by about 5 nm to about 5000 nm. The one or more micromechanical actuator can provide vertical actuation or lateral actuation by any means such as, but not limited to, piezoelectric means, electrostatic means, or combinations thereof. The optical transmission filters of such embodiments, may have transmission spectrum, reflection spectrum, or absorption spectrum in the infrared spectral region, and the infrared spectral region includes electromagnetic waves having a wavelength about 1 μm to about 100 μm (about 300 THz to about 3 THz).

Further embodiments, are directed to methods for modifying transmission of an optical transmission filter by providing an optical transmission filter such as those described above, and moving the metamaterial component vertically, laterally, or combinations thereof relative to the second component. As above, the second component can be a second metamaterial component or a natural material, and the metamaterial component and the second component can be separated by a distance of about 5 nm to about 5000 nm.

In particular embodiments, moving may include vertically or laterally changing a position of the second component relative to the metamaterial component by about 0.1% to about 50% of a wavelength of a spectral region to be modified, and in some embodiments, the spectral region may include electromagnetic waves having a wavelength about 1 μm to about 100 (about 300 THz to about 3 THz). In certain embodiments, moving may include vertically or laterally changing a position of the second component relative to the metamaterial component by about 5 nm to about 5000 nm, and in various embodiment, moving may be vertical actuation or lateral actuation carried out by piezoelectric means, electrostatic means, or combinations thereof.

In some embodiments, modifying the transmission of the optical transmission filter may include tuning the transmission spectrum in the infrared spectral region, and in other embodiments, modifying the transmission of the optical transmission filter may include modifying the transmitted wavelength spectrum by about 10% to about 200% of the center wavelength. In particular embodiments, modifying the transmission of the optical transmission filter may include modifying a wavelength from about 1 μm to about 100 μm by from about 5% to about 50% of the wavelength. In still further embodiments, modifying the transmission of the optical transmission filter may include switching the transmission spectrum in the infrared spectral region. In some embodiments, modifying the transmission of the optical transmission filter may include blocking transmission of a wavelength from about 1 μm to about 100 μm by up to 100%, and in other embodiments, modifying the transmission of the optical element may include blocking transmission of a wavelength from about 1 μm to about 100 μm by from about 50% to about 99% of the wavelength.

Additional embodiments are directed to methods for making a tunable optical transmission filter such as those described above including electromagnetically coupling a metamaterial component to a second component and operably connecting the metamaterial component and the second component with one or more micromechanical actuator capable of providing vertical actuation, lateral actuation, or combinations thereof of the metamaterial component relative to the second component. in various embodiments, the second component may be a second metamaterial component or a natural material, and the metamaterial component and the second component can be separated by a distance of from about 5 nm to about 5000 nm. In certain embodiments, each of the one or more micromechanical actuators can be capable of vertically or laterally changing a position of the metamaterial component relative to the second component by about 5 nm to about 5000 nm.

Still further embodiments are directed to articles of manufacture, including devices and other machines that include the optical transmission filters described above. For example, the optical transmission filters described herein can be used in devices for communications, thermal imaging, microscopy, spectroscopy, infrared imaging, thermal imaging, hyperspectral imaging, or chemical sensing and can be incorporated into aircraft, spacecraft, boats, automobiles, trucks, satellites, land based products, sea based products, consumer products, or combinations thereof for use by the military or civilians.

### DESCRIPTION OF DRAWINGS

Attorney Docket No.: 120209.7501

The file of this patent contains at least one photograph or drawing executed in color. Copies of this patent with color drawing(s) or photograph(s) will be provided by the Patent and Trademark Office upon request and payment of necessary fee.

For a fuller understanding of the nature and advantages of the present invention, reference should be made to the following detailed description taken in connection with the accompanying drawings, in which:

FIG. 1A shows an illustrative example SRR design.

FIG. 1B shows an SRR designed as a transmission filter for 9 μm wavelength EM energy the surface is predominantly metal (grey areas) with open apertures (dark lines). Cell size is 1.6 μm.

FIG. 2 shows a simulation of the electrical fields surrounding a representative SRR and the enhancement of the electric field near the gap.

FIG. 3 illustrates a featureless high index wafer that is microactuated vertically with respect to a metamaterial device. Vertical separation typically varies from 100 nm to ≈5 μm.

FIG. 4 shows a model of the change in transmission wavelength as the separation increases for the featureless wafer relative to the metamaterial device of FIG. 1B with diamond substrate and diamond upper medium.

FIG. 5 shows a structured high index wafer that is microactuated laterally with respect to metamaterial device. Lateral actuation by one cell is a complete tuning cycle.

FIG. 6 shows a more detailed view of the device of FIG. 5, in which (A) shows a first state in which the layers are aligned in a first position; and (B) shows a second state in which the two layers are aligned in a second position that is about ½ cell period different than the first position.

FIG. 7 shows an illustrative example of a device in which the upper and lower mediums are metamaterials and a vertical separation may be applied from about 100 nm to about 5 μm. The upper and lower mediums may be identical or non-identical. Non-identical metamaterials are illustrated here.

FIG. 8 shows an illustrative example of a device in which the upper and lower mediums are metamaterials and the second plane is microactuated laterally with respect to the first metamaterial device plane. Lateral actuation by one cell is a complete tuning cycle. Vertical separation is about 100 nm. The upper and lower mediums may be identical or non-identical. Non-identical metamaterials are illustrated here.

FIG. 9 shows a specific design for a device in which both the upper and lower elements are identical metamaterials.

FIG. 10 shows a simulation of a device designed as depicted in FIG. 9 with lateral offset actuation of two identical metamaterial layers and indicates switching behavior alternating between substantial transmission in the 8-10 μm band (State A) and the 3-5 μm band (State B) as the planes are offset laterally by ½ cell.

### Detailed Description

Before the devices and methods presented herein are described, it is to be understood that the embodiments described are not limited to the particular processes, compositions, or methodologies described, as these may vary. It is also to be understood that the terminology used in the description is for the purpose of describing the particular versions or embodiments only, and is not intended to limit the scope of the invention.

It must be noted that, as used herein, and in the appended claims, the singular forms “a,” “an,” and “the” include plural reference unless the context clearly dictates otherwise. Unless defined otherwise, all technical and scientific terms used herein have the same meanings as commonly understood by one of ordinary skill in the art. Although any methods similar or equivalent to those described herein can be used in the practice or testing of embodiments of the present invention, the preferred methods are now described. All publications and references mentioned herein are incorporated by reference. Nothing herein is to be construed as an admission that the invention is not entitled to antedate such disclosure by virtue of prior invention.

As used herein, the term “about” means plus or minus 10% of the numerical value of the number with which it is being used. Therefore, about 50% means in the range of 45%-55%.

The term “ transmission filter” as used herein is used to describe a frequency selective optical element, configured to selectively transmit electromagnetic energy of various frequencies or wavelengths by virtue of absorbing, reflecting, or transmitting one or more frequencies or wavelengths or frequency or wavelength bands. Examples of commonly used filter functionalities include but are not limited to the following: narrowband transmission, wideband transmission, narrowband absorption, high pass, low pass. The transmittance, reflectance and absorbance spectra of a given filter over a range of frequencies or wavelengths are known as its “spectral characteristics.”

The term “metamaterial” refers to the collective optical properties of a subwavelength fabricated structure, generally produced by mathematical design, for the purpose of obtaining properties not found in natural materials. Due to the subwavelength structuring, such synthetic optical materials are also called “effective media.” Typically, metamaterials are fabricated based on a unit cell, repeated laterally as regular arrays in the X and Y directions.

The term “SRR metamaterials” where SRR denotes “Split Ring Resonators” will be used herein to refer broadly to metamaterials that include geometries of metal areas on a substrate. The patterns may include split rings, but also can include patterns where no rings as such are evident. A great variety of such structures are now known to the art, aimed at different useful optical characteristics or devices. An SRR is a typical example of the unit cell design for a metamaterial, which then consists of a periodic spatial array of same.

The terms “tunable” or “dynamically tunable” as used herein are used to describe filters whose spectral behavior is subject to being continuously adjusted over a range of values by application of an external signal or impetus such as an electrical signal.

The term “switchable” as used herein is used to describe an optical filter element whose spectral characteristics are subject to being altered by application of an external signal or stimulus from a first spectral characteristic to a second spectral characteristic without necessarily transitioning continuously through intermediate states. For some applications, such as spectroscopy, tunable filters are most useful, whereas for other applications, such as comparing an image at two widely separated bands, switchable filters are more relevant.

As used herein, the terms “discontinuous spectral switching” or variations thereof denote this kind of discontinuous reorganization of the spectral characteristic of a filter, wherein the spectral characteristic is dynamically altered from one pattern to a second different pattern without necessarily transitioning through intermediate states.

Filters of all kinds and particularly transmission filters are key optical components throughout the electromagnetic spectrum. Static filters are widely used but also, dynamically tunable or switchable versions are important for many applications. Depending on the wavelength range, diverse materials and structures have been used to construct filters based on known principles. Filters for the mid-infrared (mid-IR) range (2 μm to about 15 μm wavelength) are of importance for communications, thermal imaging, microscopy, spectroscopy and many other applications. Making these filters tunable in a broadly tunable realization has been problematic. Mid-IR optical devices require special materials that differ from those used for longer or shorter wavelengths, and generally speaking, the methods used to create tunable filters at other wavelength ranges do not apply in the mid-IR due to the natural limitations of materials used at these frequencies. Therefore, achieving tunability or switchability in the mid-IR has been difficult and is a barrier to numerous desirable applications in the fields of infrared imaging, thermal imaging, hyperspectral imaging, chemical sensing, spectroscopy and communications. Systems that could use dynamic infrared filters include both military and industrial, and platforms may include spacecraft or satellites, land based, sea based, or even consumer products.

Recently, IR filters and related devices have been constructed based on the technology of electromagnetic metamaterials. Electromagnetic metamaterials are synthetic composite media whose electromagnetic properties are created by virtue of sub-wavelength scale structural features rather than the inherent properties of atoms, molecules, glasses, or crystals of natural materials. Due to the subwavelength structure, incident light waves interact with such metamaterials as if they were simply an effective medium with novel properties defined by their spectral permittivity and permeability. SRR metamaterials are a subclass of metamaterials which include a pattern of metal films on a substrate and can be predominantly substrate with patterns of metal on a minority of the surface of the substrate or predominantly metal with patterns of holes or other lines or apertures in the metal. The SRR provides a resonant behavior with well-defined spectral peaks or valleys of transmission, reflection or absorption. Metamaterials can display electromagnetic and optical properties that are not found in any natural materials and can be designed for particular uses. The structural features of most metamaterials are fabricated to be much smaller than a wavelength of electromagnetic radiation at the frequency of use.

Typically the structure of the metamaterial is planar, with arrays of repeated unit cells. The cells and their patterning and features are typically much smaller than the wavelength of intended use. The properties of these composite materials are therefore not resolved based on individual structural features. Rather, the optical properties of the material result from the collective interaction of the material and its numerous structural features with the electromagnetic radiation. Because metamaterials rely on structural features that are a fraction of the size of the wavelength of electromagnetic radiation of use, reduction in scale has proven challenging as the filtered radiation has moved from longer wavelength applications (microwaves or RF) towards shorter wavelengths (millimeter waves, infrared or visible). Many metamaterials have now been realized by use of the well-developed fabrication techniques available from the microelectronics industry, and even exotic properties such as negative refractive index, which is not known in any natural materials, have been demonstrated in metamaterials.

One subclass of electromagnetic metamaterials are based on designs for “split ring resonators” (“SRR”). Each SRR unit cell includes two surface components, a metal area and the substrate area, and the simplest SRR is a ring of metal film with a gap in the ring that is deposited on a dielectric or semiconductor substrate. The purpose of the split ring is to provide a specific electromagnetic resonance. The substrate is generally selected from materials that are low in absorption at the desired wavelength band. The permittivity (ε) of the metal ring is negative as is typical of all metals, and magnetic permeability (μ) values can be designed by the geometry of the metal lines or areas. SRR structures may also be squares, crosses, loops, bars, or various other geometrical patterns of conducting metals in dielectric substrates. At high frequencies, the gap provides capacitance and the loop provides inductance, so the metamaterial will respond to appropriate wavelengths of radiation with resonances that may selectively enhance absorption, reflectance, or transmission in ways that can be designed mathematically using various known computational techniques. Since SRR structures are typically 5× to 500× smaller than the wavelength of electromagnetic radiation of use, optical measurement of the metamaterials gives the appearance of novel bulk properties. For example, the structure scale of an SRR for use at a wavelength of 10 micrometers may include repeated pattern of cells where each cell is 1 μm to 2 μm and the features within each cell can be on the order of 0.05 to 0.5 micrometers.

SRR metamaterials have useful for the design of infrared filters, and a wide variety of spectral characteristics have been demonstrated in the IR range including absorption notch filters, transmission passband filters, edge filters, stopband filters, and others using patterns of metallic microstructures on dielectric substrates. In addition so-called “Babinet filters” or complementary filters in which the metal films and open spaces in the unit cell pattern are reversed are known; these provide narrowband transmission notches.

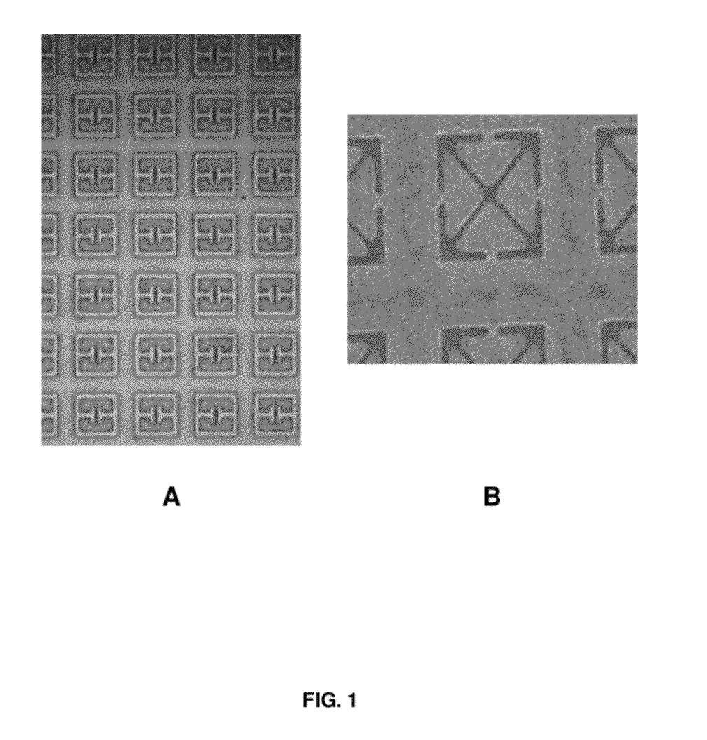

Examples of microstructured devices based on regular spatial arrays of split ring resonators (“SRR”) as unit cells for use in the IR are shown in FIGS. 1A and 1B. FIG. 1A shows an exemplary SRR design in which patterns of thin metal lines disposed on dielectric or semiconductor substrates to form split rings that are designed mathematically to provide resonances under electromagnetic (“EM”) radiation. The overall dimensions of each SRR unit cell are designed to be less or much less than the wavelength of the EM radiation irradiating the metamaterial. The SRR unit cells are analogous to artificially designed “atoms” and generally may be structured on a scale that is much smaller (about 5 to about 500 times smaller) than the resonant wavelength, due to the lumped inductance and capacitance, which are due to their structure as metallic patterns or other structural features. For example, the structures shown in the array of cells in FIGS. 1A and 1B are about 1/10 the size of the design wavelength for resonant interaction. For example, a narrowband filter with center wavelengths of about 10 micron may include SRR unit cells on the order of about 1 μm to about 2 μm, with smallest features within each individual unit cell being about 50 nm to about 100 nm. FIG. 1B shows an exemplary metamaterial having specific SRR unit cells that are 1.6 μm square cells of gold areas on a dielectric substrate, which results in a resonant transmission bandpass at a wavelength of about 9 μm. That the structural scale is so much smaller than the wavelength is a prerequisite for qualifying as a metamaterial.

SRR patterns for IR wavelengths are typically recorded by e-beam lithography. Recent fine scale lithographic technology has been developed that has allowed SRR unit cells to become even smaller, having patterns that generate resonance frequencies in the range of 30-100 THz which corresponds to 3-10 micrometers wavelength, even though the unit cells are on the order of only 0.3-2 micrometers. The e-beam resolution required for such cells, able to define features on the order of 0.05 micrometers, is readily available.

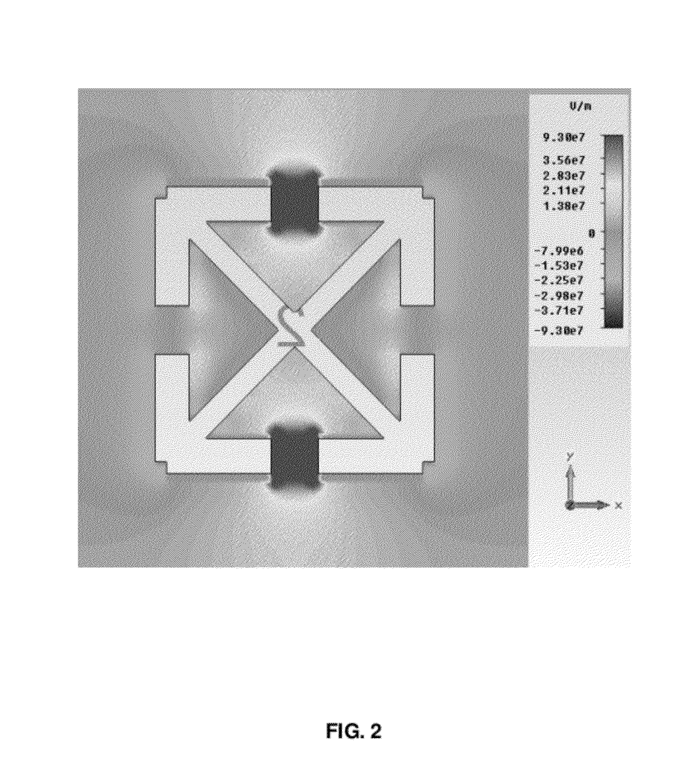

FIG. 2 shows the electrical fields excited by incident radiation of the SRR of FIG. 1B, and indicates that the gap in the ring of such split-ring resonators is a locus of enhanced electric field strength. Even for patterns that are not rings with well-defined gaps, it is possible to design metamaterials in which the electric and magnetic fields surrounding the device layer are concentrated in certain regions. This is significant because, due to the enhanced electric and magnetic fields the resonance of such cells and collection of cells will be particularly sensitive to the substrate permittivity and permeability, which together yield the refractive index, as well as the permittivity and permeability of the upper medium in those regions. Thus, the resonant frequency or frequencies of the SRR structures may be altered by substituting or altering the index of the substrate or the upper medium.

For THz wavelength metamaterials, the mechanism of tunability generally has depended on controlling the substrate permittivity and permeability by means of semiconductor charge depletion. However, tunable/switchable filters have not proven easy to achieve at mid-IR wavelengths by an extension of the substrate charge depletion method. At typical mid IR frequencies, significantly altering the refractive index (n) in available materials may become increasingly difficult because the properties of the materials commonly used in IR devices, such as semiconductors, glasses, or crystals, do not allow methods of dynamic alteration of their index properties. Thus, dynamic tuning of semiconductor and related materials appears to be limited to frequencies below 1-2 THz. On the other hand, types of materials that are known to be index tunable such as liquid crystals are typically not suitable for IR filters.

For example, the permittivity of GaAs can be changed at 1 THz by carrier density depletion in a doped layer of the semiconductor. However, this fails to work effectively at 30 THz because this frequency is above the plasma frequency of the charge carriers, so they do not follow the electric field oscillations. Thus, a mechanism for tuning that has been effective in metamaterials designed for 1 THz, will not work at 30 THz. Generally, effecting substantial changes in refractive index by active charge depletion mechanisms has proven difficult in the infrared. Thus, the tuning of infrared filters is largely an unsolved problem.

In addition to the substrate and metal components, the region immediately above the device plane can be important because electric and magnetic fields associated with the metamaterial device plane extend some distance away from the surface of the metamaterial. For most metamaterial devices, the medium through which the electric and magnetic fields extends above the device plane (the “upper medium”) is air, but in principle, the upper medium could be a third material and tuning of the a metamaterial device may be achieved by means of changing the upper medium or be substituting a different material for the upper medium. Thus, embodiments of the invention are directed to metamaterial devices that include an upper medium that can be modified to influence the electromagnetic characteristics of the underlying metamaterial device. In some embodiments, modifying the electromagnetic characteristics of the underlying metamaterial device can be accomplished by introducing material above the metamaterial.

Various embodiments of the invention are directed to a device that includes a metamaterial device and an upper medium that can be modified to influence the electric and magnetic fields associated with the metamaterial device. In such embodiments, the upper medium may overlay at least one face of the metamaterial device, and may be positioned to interact with electric and magnetic fields extending away from the device plane of the metamaterial device. The upper medium may be modified by any means. For example, in some embodiments, the upper medium may be positioned to allow for vertical actuation of the upper medium relative to the metamaterial device, and in other embodiments, the upper medium may by positioned to allow for lateral actuation. The upper medium may be composed of any material, and in certain embodiments the upper medium may have a different index of refraction than the metamaterial device. For example, in various embodiments, the upper medium may be a semiconductor wafer, glass, or crystal, and in certain embodiments, the upper material may be a second metamaterial rather than a natural material.

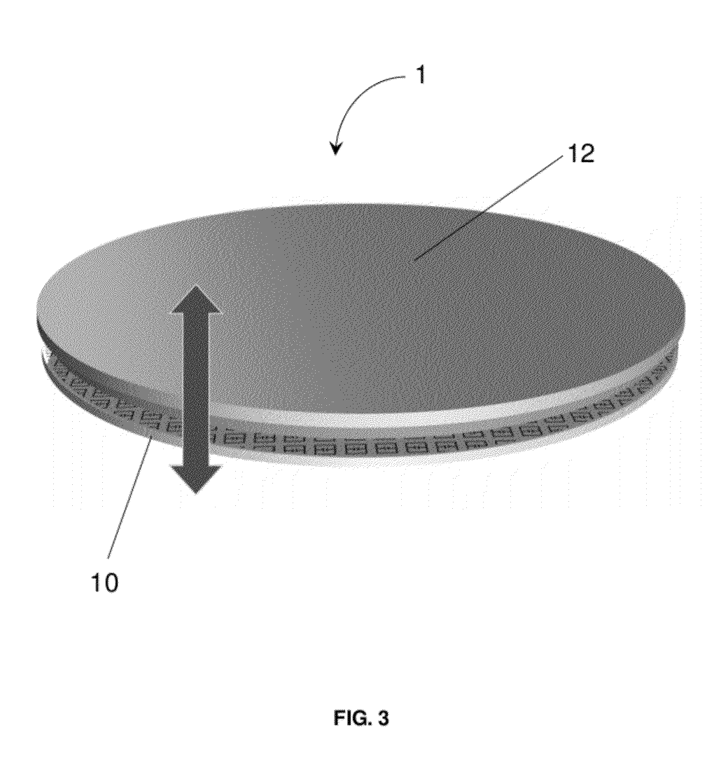

More specific exemplary embodiments include a device in which the upper medium is a semiconductor wafer that is positioned and arranged to be vertically actuated allowing the distance between the metamaterial device and the upper material to be increased or decreased to tune the filter capabilities of the metamaterial device. FIG. 3 provides a model for such a device. As shown in FIG. 3, the device 1 includes a metamaterial device component 10 and upper medium 12 that is a wafer component and is positioned to overlay the metamaterial device component. The arrow indicates the direction of movement of the upper medium relative to the metamaterial device and indicates that vertical actuation will allow the space between the upper medium and the metamaterial device to be increased or decreased, and in some embodiments such devices may be tuned or switched by physically moving the secondary material 12 vertically relative to the metamaterial device component 10 allowing for controlled separation over a range such as, for example, about 100 nm to about 5 μm. The upper medium 12 in of FIG. 3 is an unpatterned wafer that can be prepared from any advantageous material such as, for example, a high index semiconductor. Such devices may be useful as dynamic EM filters.

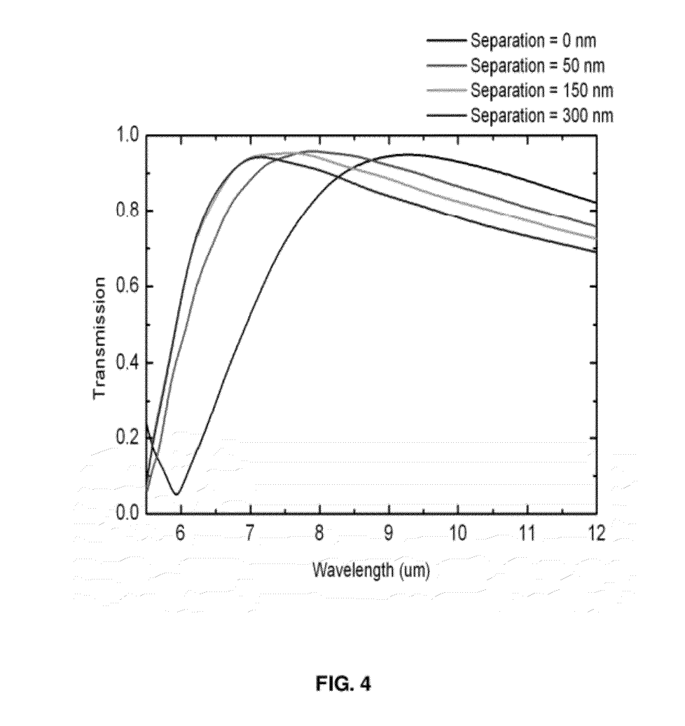

FIG. 4 shows the simulated electromagnetic response of a transmission filter composed of an array of SRR cells, when the region above the metamaterial plane is provided with a solid transparent material at standoff separations of 300 nm, 150 nm, 50 nm, and 0 nm respectively (0 means contact) for a device in which the substrate of the metamaterial device component and the upper medium are both diamond. These data predict that such a filter can be effectively tuned from a transmission maximum at 7.2 μm to 9.5 μm. Although the second layer in this example is the same material as the substrate, it is believed that the tuning will be even greater than shown if the second layer has a relatively higher index than the substrate, and computer simulations show that the amount of tuning achieved through a given separation change may be larger if the index of refraction of the upper medium is substantially greater than the index of refraction of the substrate. For example, the, change in transmission wavelength, and therefore, tuning will be greater for a device in which the substrate of the metamaterial device component is diamond (index, 2.24) and the upper medium is Ge (index, 4.2) than if the upper medium is also diamond.

The range of mechanical motions required to substantially alter the spectral characteristics of the transmission filter, are very small, only on the order of the dimensions of the unit cell, or even less, which as has been described is much smaller than the wavelength of the radiation being controlled. “Substantially alter” the transmission filter characteristics may be defined to mean tuning the wavelengths selected by 20% to 200% of center wavelength, or switching the transmitted band to another band where the center wavelength is 100% or more different from the first. That such small micro-mechanical displacements are required is a direct consequence of working with metamaterials whose fine structure is much smaller than a wavelength.

In other exemplary embodiments, the upper medium may be positioned and arranged to be actuated laterally relative to the metamaterial device component, and in such embodiments, the upper medium wafer may be structured to include, for example, discrete mesas, columns, or fingers that can interact with the unit cells of the metamaterial device component which maintain a fixed vertical separation, such as 100-1000 nm between the metamaterial device component and the upper medium. Lateral actuation may, therefore, present alternating high index and low index (air) materials to the sensitive loci, and without wishing to be bound by theory may provide a device in which small lateral movements can effectively modify the properties of the metamaterial device component. For example, in some embodiments, the full tuning range may be accomplished by lateral microactuation of only ½ the cell pitch.

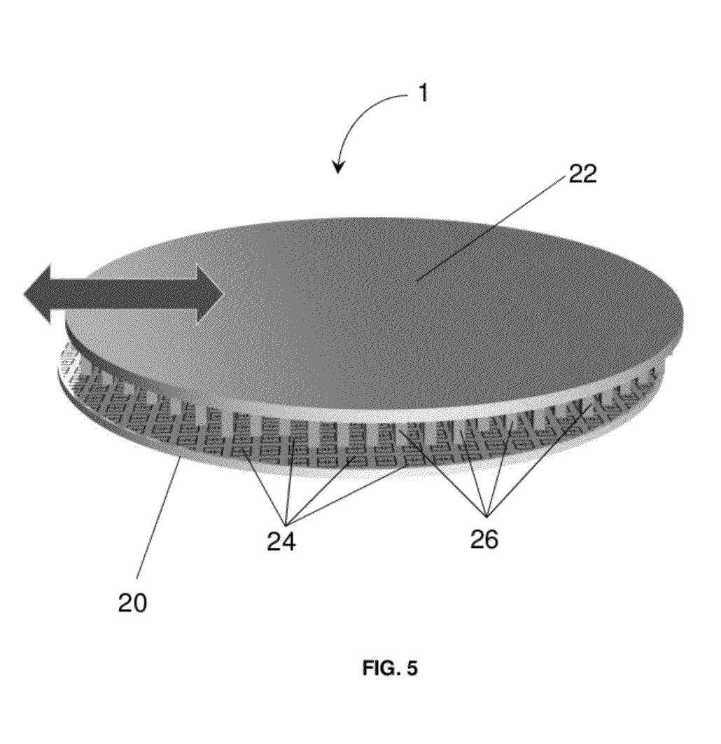

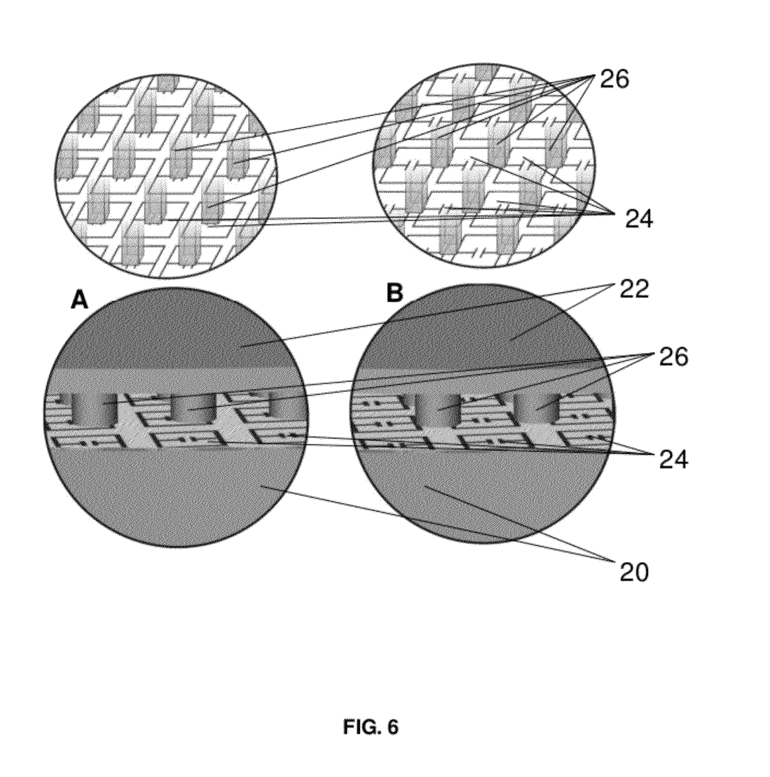

FIG. 5 an illustrative example of a device 2 of such design. The device 2 includes a metamaterial device component 20 and a structured upper medium 22 that includes pillars or mesas 26 designed to interact with the SRR 24 of the metamaterial component 20. FIG. 6 shows a closer representation of the exemplary device of FIG. 5. Panels A of FIG. 6 show the patterned upper medium 22 in a first position in which a portion of the pattern which resembles pillars 26 in this depiction contact a portion of each SRR 24 of the metamaterial device component 20. Panels B of FIG. 6 shows the patterned upper medium 22 in a second position after lateral micromechanical actuation that has repositioned upper medium 22 such the pillars 26 contact the metamaterial device component 20 between the SRR 24. For a metamaterial having SRR unit cells that are 1.6 μm squares, the movement illustrated in FIG. 6 would be lateral movement of only about 0.8 μm.

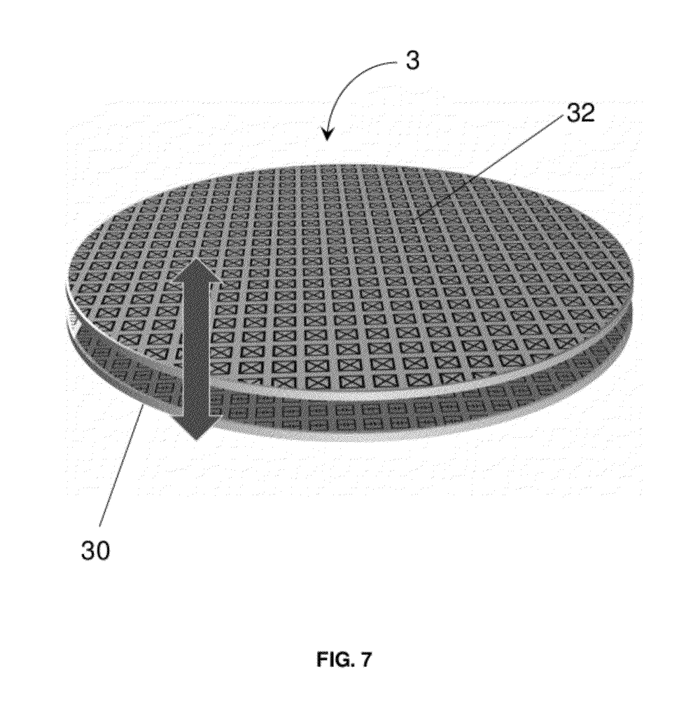

In still other exemplary embodiments, the upper medium may be a second metamaterial that is positioned and arranged to be actuated vertically relative to a metamaterial device, and in further exemplary embodiments, the upper medium may be a second metamaterial that is positioned and arranged to be actuated laterally relative to a metamaterial device. FIG. 7 shows an illustrative example of a device that includes two metamaterials. As shown in FIG. 7, such devices 3 may include a metamaterial device component 30 and an upper medium that is a second metamaterial 32. As indicated by the arrow, tuning may be effectuated by vertically actuating the upper medium, second metamaterial 32 relative to the metamaterial device component 30. Without wishing to be bound by theory, the effect of vertical actuation may be to change the gap dimension of the device thereby modifying the SRR resonance of the metamaterial component and tuning the device. In such embodiments, the upper medium, second metamaterial may be either identical to the lower metamaterial component or the upper medium, second metamaterial may be different from the lower metamaterial component. Vertical microactuation of such devices may be carried out over a range of from about 100 nm to about 5 μm.

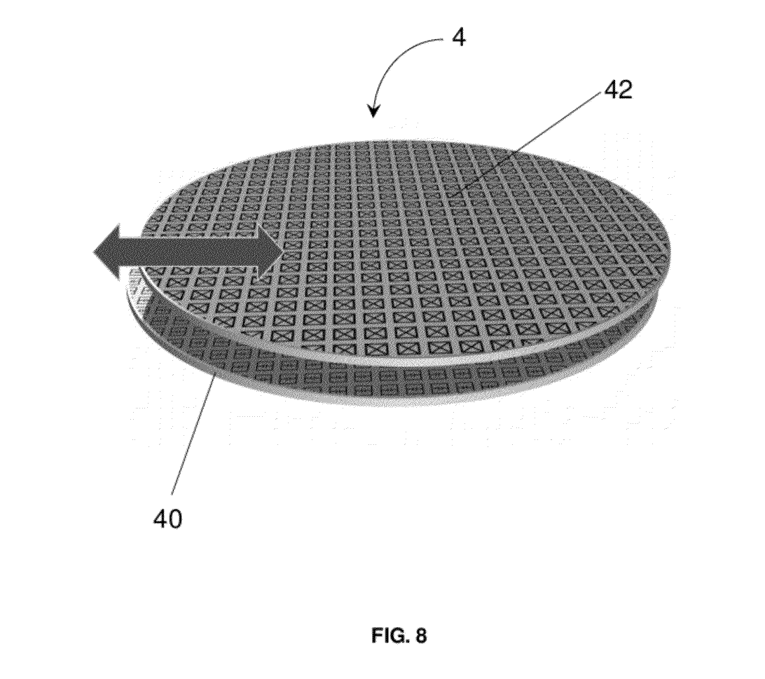

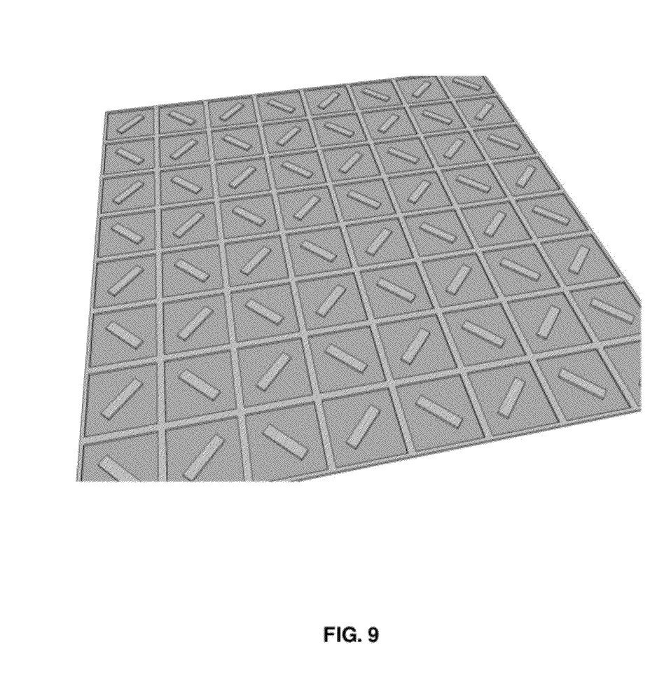

In still further exemplary embodiments, the device may include an upper medium, second metamaterial that is positioned and arranged to be moved laterally relative to the metamaterial component. In such embodiments, the separation between the metamaterial component and the upper medium, second metamaterial may be fixed and, in certain embodiments, may be from about 100 nm to about 1000 nm. FIG. 8 shows one example of such a design. In FIG. 8, the device 4 includes an metamaterial component 40 and an upper medium, metamaterial 42 that are different. As indicated by the arrow, the upper medium, metamaterial may be laterally actuated to modify the properties of the metamaterial component. While FIG. 8 shows an upper medium, metamaterial 42 that is different than the underlying metamaterial component 40 in some embodiments, the metamaterial component and the upper medium, metamaterial may be the same. For example, FIG. 9 shows the design for an exemplary metamaterial 50 in which the lower metamaterial component and the upper medium, metamaterial are identical.

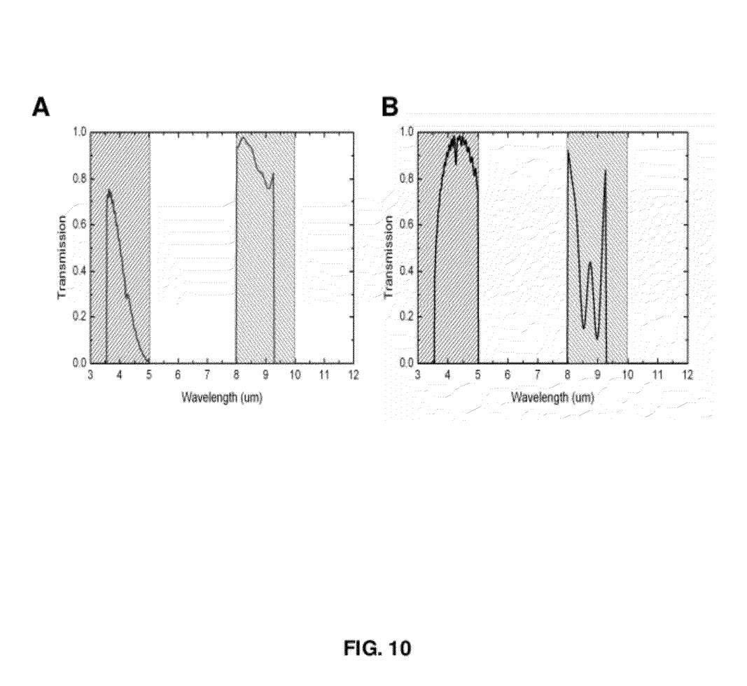

Without wishing to be bound by theory, embodiments that include an upper medium, which is itself a metamaterial may be particularly well adapted to filters that are switched between initial and final states without transitioning the intermediate states, i.e., switchable filters, as indicated by FIG. 10. FIG. 10 shows a computer model of a device that includes an upper medium, metamaterial and shows the effect of displacing the planes laterally relative to each other by only ½ the cell pitch effectively reorganizes the transmission spectrum from substantial transmission at 3 μm to 5 micrometers and substantial blocking at 8 μm to 12 μm, to the reverse. Thus, the filter alternates between transmitting these two bands, and the lateral motion required is extremely small, on the order of a cell size, which is a small fraction of a wavelength.

Without wishing to be bound by theory, lateral actuation in which the upper medium is moved laterally relative to the metamaterial component may result in periodic tuning or switching over the full dynamic range because the cell period is so small, regardless whether the upper medium is a natural material or a metamaterial. Lateral actuation of a structured high index upper medium may also have the advantage that by simply moving it continuously at a constant speed in one lateral direction, the effective response of the filter can be periodically tuned, cycling over its full range whenever the displacement is equal to the cell period, which may be, for example, 1 μm. As an example, by laterally displacing the semiconductor layer relative to the metamaterial layer in a continuous fashion at a rate of 10 mm per second, the filter may be tuned over its full range at the rate of 10,000 complete cycles per second. Thus, due to the very small micromechanical displacement required for wide tuning, it may be possible to effect periodic tuning of the filter at quite high speeds using a simple linear motion. In some embodiments, the mechanism of tuning comprising strong electromagnetic coupling from one metamaterial layer to a second layer separated by a fraction of a wavelength, even if the second layer is simply a structured (patterned) dielectric, and in such embodiments, the micromechanical mechanism simply controls the average refractive index near the metamaterial layer. Therefore, periodic tuning or switching of such structures can be effected at very high speeds.

In embodiments in which the upper medium is a metamaterial, in some embodiments, the upper medium may be identical to the material used in the metamaterial component, and in other embodiments, the metamaterials used in each of the upper medium and metamaterial component may be non-identical. For example, in some embodiments, the metamaterial component may have a different design, pattern, or type of metamaterial than the upper medium, and in other embodiments, the upper medium may have a different array of SRRs from the metamaterial component. Thus, in some embodiments, the device may include a first metamaterial patterned layer and a second metamaterial patterned layer where the first metamaterial patterned layer has a different pattern than the second metamaterial patterned layer. In particular embodiments, the patterns may be designed to achieve specific resonances through cooperative interactions.

Without wishing to be bound by theory, two metamaterial layers in close proximity may couple to one another strongly, with one becoming the electromagnetic environment of the other. Therefore, two parallel layers of metamaterials in close proximity may have a different net transmission/reflection spectrum than a single layer, whether the two layers are identical or different. This may lead to two-layer designs where relative lateral displacement by ½ the cell period leads to substantial changes in the net optical spectral characteristics of the assembly. In all cases, two layer metamaterials may depend on the exact registration of one layer relative to the other, because of the underlying coupling of the fields, especially near the gaps of split rings. Micromechanical actuation of two metamaterial layers relative to each other may also cause either dynamic tuning or substantial modification of the net filter characteristic, which can lead to advantageous types of switching behavior. Thus, a two layer metamaterial device may include metallic patterns such as SRR's or other patterns in both layers, which combine to yield resonances. These two layers may, in some embodiments, be identical patterns or, in other embodiments, different patterns designed to work together to achieve a desired filter characteristic. A very small micromechanical lateral displacement of the first layer relative to the second may be sufficient to cause a substantial change in the net spectral characteristic.

Embodiments of the invention also include methods for modifying the transmission wavelength of a metamaterial by providing an upper medium overlying at least a portion of a metamaterial component to create tunable or switchable metamaterial filters for the mid-IR wavelengths and moving the upper medium relative to the metamaterial component. In some embodiments, movement of the upper medium may be carried out by vertically actuating in which the upper medium is moved away from or closer to the metamaterial component. In other embodiments, movement of the upper medium may be carried out by laterally actuating the upper medium in which the separation between the metamaterial component and the upper medium remains fixed and the upper medium is moved laterally relative to the metamaterial component. As described above, in some embodiments, the upper medium may be a natural material, such as, a superconductor wafer, glass, or crystal and in other embodiments, the upper medium may be a second metamaterial, which can be either the same or a different metamaterial than the metamaterial component. In still other embodiments, the upper medium may be structured or non-structured.

The embodiments provided above are based on five principles. First, certain regions in the metamaterial plane can be provided by design where electric or magnetic fields are concentrated, and change of the index of the medium or changing the medium itself at these locations leverages the tuning effect by altering the resonance properties. Second, while it has proven difficult or impossible for the index of the substrate or upper medium to be dynamically controlled by charge carrier depletion means in the case of infrared components, it is nevertheless possible to effectively change the index in the most sensitive regions simply by mechanically actuating the placement of alternative materials in said sensitive regions. In other words, moving a high index material into a sensitive region which before was occupied by air, effectively creates a very large change in refractive index. Third, this can be effected either by vertical or lateral microactuation of a high index upper medium relative to the metamaterial device layer. Fourth, due to the very small size of the unit cells relative to the wavelength, the amount of micromechanical actuation required to effect tuning or switching by movement of certain structures relative to others, is very small. For example, a filter designed for use at 10 μm can be broadly tuned by micromechanical actuation on the order of less than 1 μm that is the size of the unit cell rather than a wavelength. This is a significant advantage over other types of optical device tuning which require movements of at least a wavelength, or several wavelengths, or more, for substantial tuning. Fifth, the micromechanical actuation of an upper medium to control its proximity relative to the metamaterial device layer can, alternatively, use an upper medium which is itself a metamaterial rather than a natural material. This greatly expands the range of designs and optical spectral characteristics which can be obtained.

Without wishing to be bound by theory, if the material immediately above or below or in proximity to the gaps of the split rings can be changed from a relatively low index to a relatively high index material (but still transparent at the wavelength of use), the resonant frequency of the SRRs may be significantly tuned due to the change in effective capacitance or inductance. The accessible region for the index to be changed is above the metamaterial plane. The change to the index may be accomplished by physically moving pieces or layers of high index materials in or out of the key regions near the gaps, mechanically. Because of the small scale of the cells and the small extent of the fringing fields, the amount of mechanical movement required to obtain tuning or switching this way can be very small. The effective space-averaged index of the region immediately above the metamaterial plane can be controlled by bringing a second wafer of some relatively high index material in proximity to the filter layer, and then varying the distance from the filter layer surface by a mechanical or micromechanical means, such as are well known in the art of MEMs for micro devices.

Electromagnetic theory shows that the resonant frequency of split ring resonators or similar metastructures can be highly sensitive to the refractive index (or equivalently, the permittivity and permeability) of the filter substrate and also the space within a fraction of a wavelength immediately above the metamaterial layer. This sensitivity is particularly strong in the vicinity of the gap of split rings because of the large local electrical fields at the gap. It is further believed that by replacing the air above the gap in the split ring layer with a higher index material, the electromagnetic environment may be substantially altered, the effective capacitance of the gap region may be changed, and the device will be tuned in frequency. Alternatively, a medium with strong magnetic properties brought close to the ring, to replace or partially replace the air above the device plane with a higher permeability, may also alter the resonant frequency. Thus, by positioning the metamaterial resonator layer and the semiconductor or metamaterial other material layer such that the layers of the metamaterial filter can be physically moved relative to one another and providing a mechanism to allow the metamaterial resonator layer and the semiconductor or metamaterial other material layer to be moved, a tunable metamaterial filter can be produced. The transmission wavelength, or center wavelength, may be tuned by as much as 100% or even 400% of the center wavelength in this manner allowing for a tunable filter that can provide a narrow or wide band of transmission throughout a substantial IR spectral range. In some embodiments, the tuning method may modify transmission frequencies in the IR spectral range, and in certain embodiments, filter elements with such large dynamic tuning ranges can be achieved throughout the mid IR, for center wavelengths from about 2 μm to about 30 μm in wavelength (about 150 THz to about 10 THz frequency). In other embodiments, the tuning methods embodied herein may be used to modify the transmission frequency of any material and may be used to modify transmission or reflection or absorption in any spectral range.

While particular embodiments are directed to filters useful for filtering EM in the IR spectral range having wavelength of about 1 μm to about 100 μm, a frequency of about 300 THz to about 3 THz, and tuning filters in such spectral range, the principles for achieving such filtering and for tuning the transmission peak described herein can be applied to filters used for filtering EM radiation of any wavelength or frequency.

In various embodiments, the metamaterial and upper medium of the devices of the invention may be positioned such that they can be physically moved relative to one another. For example, in some embodiments, the metamaterial and the secondary material the devices may be positioned relative to one another such that at least two of the layers can be translated laterally relative to one another, and in other embodiments, the at least two layers of the metamaterial filter may be positioned such that they can be translated vertically relative to one another. Micromechanical actuation may be carried out by any means known in the art. For example, the secondary material may be moved either laterally or vertically relative to the metamaterial by piezoelectric, electrostatic, or other methods known to the MEMS art. Even an actuation of less than 1 μm will be effective in widely tuning the metamaterial resonance. In some embodiments, vertical microactuation may be carried out by an electrical voltage which can be applied to a doped semiconductor upper medium that provides an electrostatic attraction between the upper medium and the metamaterial component.

The upper medium may be composed of any material provided that the secondary material is transparent at the wavelength at which the device is to be used. In certain embodiments, the upper medium may have a different index of refraction than the metamaterial component. Examples of secondary materials encompassed by embodiments of the invention include monolithic semiconductor or dielectric materials, structured or patterned semiconductor or dielectric materials, and the like or combinations material or two or more layers of materials, and in some embodiments, the secondary material may be a second metamaterial. The index of refraction of such secondary materials may, generally, contrast the index of refraction of the metamaterial, and in certain, embodiments, the index of refraction for the secondary material may be higher than the index of refraction for the metamaterial.

Similarly, the metamaterial component or an upper medium composed of a metamaterial may be prepared from any metamaterial known in the art. In general, these metamaterials may include an array of repeated unit cells in which each cell bears a pattern of metal traces on a dielectric or semiconductor substrate. In particular embodiments, the metamaterial may be patterned or structured to exhibit resonant behavior that provides effective optical properties for high transmission over a desired bandwidth at IR frequencies. In embodiments in which the metamaterial is patterned, the design of the pattern may include any conventional metamaterial pattern including, but not limited to, split rings, Babinet split rings, squares, bars, areas, crosses, multilayer designs that incorporate electric and magnetic resonances, and combinations thereof. In certain embodiments, the metamaterial or secondary material may include an array of SRR resonators, and such embodiments are not limited by any particular arrangement or geometry. In some embodiments, the metamaterial layer may be designed to include one or more conventional split rings such as those described above. In other embodiments, the metamaterial layer may be designed, for example, to include one or more concentric rings where the ring may be a circular, triangular, rectangular, pentagonal, hexagonal, septagonal, octagonal, and the like ring structure. In other embodiments, the split rings may be arranged in parallel such that two or more split rings are side-by-side. Loops or rings may intersect to form complex geometries. In still other embodiments, a metamaterial may be designed to include two or more split rings arranged in parallel and the individual split rings may share a side. In still other embodiments the patterns may be metal areas over the majority of the device plane with apertures over a minority of the device plane formed of holes, rings, etc.

Embodiments are not limited by the type of metal used as the metal component of such metamaterials, and any metal known and useful in the art may be used in various embodiments of the invention. In certain embodiments, the metal may exhibit high conductivity and high reflectance at mid-IR wavelengths. In some embodiments, the metal component may be, for example, gold (Au), silver (Ag), copper (Cu), platinum (Pt), aluminum (Al), and the like. In particular embodiments, the metal component may be gold (Au). The metal component may be provided at any suitable thickness sufficient to create the metamaterial pattern. For example, in some embodiments, the metal component may be provided as a thin film having thickness of less than about 1 μm, less than about 100 nm, or about 50 nm.

The substrate material of the metamaterial component or an upper medium composed of a metamaterial of various embodiments may be any substrate material known and useful in the art by virtue of its low absorption in the wavelength band of interest. For example, in some embodiments, for use in the 2 μm to 12 μm region, the substrate material may be any material including, but not limited to diamond, gallium arsenide (GaAs), zinc sulfide (ZnS), Ge, SiGe, GaInP AlGaAs, GaInAs AlInGaP, GaAsN, GaN, GaInN, InN, GaInAlN, GaAlSb, GaInAlSb, CdTe, MgSe, MgS, 6HSiC, ZnTe, CgSe, GaAsSb, GaSb, InAsN, 4H—SiC, a-Sn, BN, BP, BAs, AlN, ZnO, ZnSe, CdSe, CdTe, HgS, HgSe, PbS, PbSe, PbTe, HgTe, HgCdTe, CdS, ZnSe, InSb, AlP, AlAs, AlSb, InAs, and AlSb. In particular embodiments, the substrate may be diamond, gallium arsenide (GaAs), or zinc sulfide (ZnS).

The thickness of the substrate component may vary among embodiments and may be of any thickness known in the art. In certain embodiments, the substrate component may be of such thickness that it is transparent to radiation in the spectral region of the EM radiation being filtered. For example, in some embodiments, the substrate component may have a thickness of about 1 mm to about 100 nm. In other embodiments, the substrate component may have a thickness of about 10 μm to about 100 nm, and in still other embodiments, the substrate component may have a thickness of about 1000 nm to about 500 nm. In embodiments in which the EM being filtered is in the IR spectral range having a wavelength of about 1 μm to about 100 μm, a frequency of about 300 THz to about 3 THz, the thickness of the substrate layer may be about 100 μm to about 500 μm and, in particular embodiments, the substrate layer may have a thickness of about 250 μm. In other embodiments that feature a multiple layered substrate, the dynamic dielectric material may about 50 nm to about 1 μm and the base substrate may have a thickness of about 100 μm to about 500 μm.

In further embodiments, the metamaterial component of the invention may include a base or support substrate layer. In such embodiments, the material used to provide the base or support layer may be any material having static optical properties with suitably high transmissive qualities over a broad range of IR spectrum. Non-limiting examples of suitable supporting or base materials include silicon, quartz, ceramic materials and combinations thereof and the like.

In some embodiments, the upper medium may include a semiconductor material prepared from materials including, without limitation, diamond, Si, gallium arsenide (GaAs), zinc sulfide (ZnS), Ge, SiGe, GaInP AlGaAs, GaInAs AlInGaP, GaAsN, GaN, GaInN, InN, GaInAlN, GaAlSb, GaInAlSb, CdTe, MgSe, MgS, 6HSiC, ZnTe, CgSe, GaAsSb, GaSb, InAsN, 4H—SiC, a-Sn, BN, BP, BAs, AlN, ZnO, ZnSe, CdSe, CdTe, HgS, HgSe, PbS, PbSe, PbTe, HgTe, HgCdTe, CdS, ZnSe, InSb, AlP, AlAs, AlSb, InAs, and AlSb or the like. In some embodiments, the upper medium may be composed of the same material as the metamaterial substrate, and in other embodiments, the upper medium may be composed of a material having a higher refractive index than the metamaterial component.

In certain embodiments, the upper medium may be patterned. For example, in some embodiments, as illustrated in FIG. 5 and FIG. 6, the pattern may provide for projections that are capable of interacting with the metamaterial layer. In other embodiments, pattern of the upper medium may provide for electronic interactions that modify the transmission wavelength of the metamaterial layer. In some embodiment, a high index upper medium may be etched into a ‘waffle’ pattern with mesas, pillars, or fingers on the same spatial period as the underlying filter as illustrated in FIG. 5 and FIG. 6. The mesa-etched wafer may be placed in contact with the device surface and lateral microactuation may be used to slide or translate the patterned high index layer laterally relative to the metamaterial component so that the high index regions may be positioned over the gap regions or moved away from the gaps, as desired as illustrated in FIG. 6. Depending on the details of design, a very small lateral translation of the metamaterial component relative to the upper medium (a small fraction of a wavelength) may substantially modify the filter response allowing for dynamic tuning.

In some embodiments, the metamaterial filter may be configured to provide continuous tuning. In such embodiments, the metamaterial component and the upper medium may be moved smoothly relative to one another to provide a smooth transition between narrowband transmission wavelengths. Thus, a metamaterial filter may provide, for example, a narrowband transition at a center wavelength of about 3 μm to narrowband transmission at center wavelength of about 5 μm, traversing all the wavelengths in between. In other embodiments, the metamaterial filter may have two discrete states instead of being tuned continuously tuned. In such embodiments, the metamaterial resonator layer and the semiconductor or metamaterial other material layer may be arranged to provide a first pattern that may be dynamically reorganized to provide second, different pattern that provides a different spectral response from the first pattern of transmission/reflection/absorption. For example, in some embodiments, passband filters may be configured to transmit the entire 3-5 μm sub-band when in a first state and may be reorganized into a second state which transmits the entire 8-12 μm sub-band without traversing the wavelengths in between. In still other embodiments, optical devices may be configured to switch from being highly transmissive to highly reflective at a given wavelength band by moving the secondary material relative to the metamaterial.

Embodiments are also directed to a method of using such metamaterials filters including the steps of displacing a upper medium relative to a metamaterial component, and by such displacement, tuning or switching of the transmission wavelength of the metamaterial. The displacement may be either lateral or vertical and may generally be carried out by micromechanical actuation. Without wishing to be bound by theory, the method of using the metamaterial devices of embodiments described herein takes advantage of the resonant frequency or other spectral behavior of a metamaterial which is highly sensitive to the material properties such as permittivity and permeability, in the region a fractional wavelength above the device layer, especially at gaps of split rings; and the cell size of the metamaterials, which is typically a small fraction of the resonant wavelength, may require a small amount of physical movement required to effectively change the optical environment. As shown in FIG. 6, adjusting the distance between the secondary layer and the metamaterial pattern such as, for example, split rings, can effectively tune the device by altering the space-averaged index in the upper half space.

Certain embodiments are directed to methods for preparing the metamaterial filters described herein. Fabrication of such materials may be carried out by any method known in the art. For example, in some embodiments, a metamaterial may be prepared by depositing a metal component on a surface of a substrate in a pattern of exposed substrate and coated metal portions using photolitohography, pattern stamping, photomasking, or electron beam lithography to create an array of individual metamaterials. In other embodiments, the metal component may be depositing on a surface of a substrate as a continuous or substantially continuous sheet, and a pattern of exposed substrate and coated metal may be created using various etching techniques. In still other embodiments, the method may include the step of depositing a substrate material onto a base or support substrate and depositing a metal component onto the substrate material. The substrate materials, base or support substrate materials, and metal components of various such embodiments include any of the materials described above.

### EXAMPLES

Although the present invention has been described in considerable detail with reference to certain preferred embodiments thereof, other versions are possible. Therefore the spirit and scope of the appended claims should not be limited to the description and the preferred versions contained within this specification. Various aspects of the present invention will be illustrated with reference to the following non-limiting examples. The following examples are for illustrative purposes only and are not to be construed as limiting the invention in any manner.

### Example 1

A diamond-substrate metamaterial can be prepared by providing a secondary material of the same diamond substrate positioned to overlay the metamaterial and separated by a variable standoff distance, as in the scheme of the First Embodiment. The curves of FIG. 4 show the expected standoff separations of 300 nm, 150 nm, 50 nm, and 0 nm respectively (0 means contact). These data show that a filter designed as embodied herein can be effectively tuned from a transmission maximum at 7.2 μm to 9.5 μm. Although the second layer in this example is the same material as the substrate, it is believed that the tuning will be even greater than shown if the second layer has a relatively higher index than the substrate.

### Example 2

A two layer filter will be designed to obtain a desired characteristic: a high transmission in the 3-5 μm range and low transmission in the 8-12 μm range. Next, one layer will be shifted in relative to the second by ½ period and the effect on the spectrum should be observed. The design was then adjusted to obtain a desired second characteristic, i.e. to reverse the ranges. The design procedure is iterated until both states are optimized.

### Example 3

FIG. 9 shows the layer pattern of each of the two layers of an identical two layer metamaterial filter designed so that lateral displacement will cause the filter to substantially change the overall character of its transmission spectrum. In this embodiment, the second layer is identical to the first layer. This example is intended to switch from transmitting mostly in the 3-5 μm band to translating mostly in the 8-12 μm band.

FIG. 10 illustrates the two transmission states which result, which are effected simply by displacing the two layers of laterally relative to one another by one half the cell period. As shown in this computational simulation, the net transmittance of the filter device is substantially shifted from the 3-5 μm window to the 8-12 μm window, simply by shifting one layer relative to the second by a very small distance on the order of 1 μm.

What is claimed is:

1. An optical transmission filter comprising:
a first patterned metamaterial layer;
a material layer electromagnetically coupled to the first patterned metamaterial layer; and
one or more micromechanical actuator operably connecting the first patterned metamaterial layer and the second metamaterial layer, the one or more micromechanical actuator being capable of providing vertical actuation, lateral actuation, or combinations thereof of the first patterned metamaterial layer relative to the second metamaterial layer.

2. The optical transmission filter of claim 1, wherein the material layer is a second patterned metamaterial layer.

3. The optical transmission filter of claim 2, wherein each of the patterned metamaterial layer and the second patterned metamaterial layer comprise a metal patterned on a substrate to produce an array of split ring resonators.

4. The optical transmission filter of claim 2, wherein each of the patterned metamaterial layer and the second metamaterial layer individually comprise a substrate selected from the group consisting of diamond, GaAs, ZnS, Ge, SiGe, GaInP, AlGaAs, GaInAs, AlInGaP, GaAsN, GaN, GaInN, InN, GaInAlN, GaAlSb, GaInAlSb, CdTe, MgSe, MgS, 6HSiC, ZnTe, CgSe, GaAsSb, GaSb, InAsN, 4H—SiC, a-Sn, BN, BP, BAs, AlN, ZnO, ZnSe, CdSe, CdTe, HgS, HgSe, PbS, PbSe, PbTe, HgTe, HgCdTe, CdS, ZnSe, InSb, AlP, AlAs, AlSb, InAs, and AlSb.

5. The optical transmission filter of claim 2, wherein the patterned metamaterial layer and second patterned metamaterial layer are the same or different.

6. The optical transmission filter of claim 1, wherein the material layer is a natural material layer.

7. The optical transmission filter of claim 6, wherein the natural material layer is selected from the group consisting of diamond, GaAs, ZnS, Ge, SiGe, GaInP, AlGaAs, GaInAs, AlInGaP, GaAsN, GaN, GaInN, InN, GaInAlN, GaAlSb, GaInAlSb, CdTe, MgSe, MgS, 6HSiC, ZnTe, CgSe, GaAsSb, GaSb, InAsN, 4H—SiC, a-Sn, BN, BP, BAs, AlN, ZnO, ZnSe, CdSe, CdTe, HgS, HgSe, PbS, PbSe, PbTe, HgTe, HgCdTe, CdS, ZnSe, InSb, AlP, AlAs, AlSb, InAs, and AlSb.

8. The optical transmission filter of claim 1, wherein the material layer further comprises pillars configured and arranged to interact with components of a pattern on the metamaterial layer.

9. The optical transmission filter of claim 8, wherein the material layer is selected from the group consisting of metamaterials and natural materials.

10. The optical transmission filter of claim 1, wherein the patterned metamaterial layer and the material layer are separated by a distance of from about 5 nm to about 5000 nm.

11. The optical transmission filter of claim 1, wherein each micromechanical actuator is configured to vertically change the distance between the patterned metamaterial layer and the material layer by about 5 nm to about 5000 nm.

12. The optical transmission filter of claim 1, wherein each micromechanical actuator is configured to laterally change a position of the first patterned metamaterial layer relative to the material layer by about 5 nm to about 5000 nm.

13. The optical transmission filter of claim 1, wherein the one or more micromechanical actuator provides vertical actuation or lateral actuation by piezoelectric means, electrostatic means, or combinations thereof.

14. The optical transmission filter of claim 1, wherein the optical transmission filter comprises transmission spectrum, reflection spectrum, or absorption spectrum in the infrared spectral region.

15. The optical transmission filter of claim 7, wherein the infrared spectral region comprises electromagnetic waves having a wavelength about 1 μm to about 100 μm (about 300 THz to about 3 THz).

16. A method for modifying transmission of an optical transmission filter comprising:
providing an optical transmission filter comprising a metamaterial component electromagnetically coupled to a second component; and
moving the metamaterial component vertically, laterally, or combinations thereof relative to the second component.

17. The method of claim 16, wherein the second component is selected from the group consisting of second metamaterial components and natural materials.

18. The method of claim 16, wherein the metamaterial component and the second component are separated by a distance of about 5 nm to about 5000 nm.

19. The method of claim 16, wherein moving comprises vertically or laterally changing a position of the second component relative to the metamaterial component by about 0.1% to about 50% of a wavelength of a spectral region to be modified.

20. The method of claim 19, wherein the spectral region comprises electromagnetic waves having a wavelength about 1 μm to about 100 μm (about 300 THz to about 3 THz).

21. The method of claim 16, wherein moving comprises vertically or laterally changing a position of the second component relative to the metamaterial component by about 5 nm to about 5000 nm.

22. The method of claim 16, wherein moving comprises vertical actuation or lateral actuation by piezoelectric means, electrostatic means, or combinations thereof.

23. The method of claim 16, wherein modifying the transmission of the optical transmission filter comprises tuning the transmission spectrum in the infrared spectral region.

24. The method of claim 16, wherein modifying the transmission of the optical transmission filter comprises modifying the transmitted wavelength spectrum by about 10% to about 200% of the center wavelength.

25. The method of claim 16, wherein modifying the transmission of the optical transmission filter comprises modifying a wavelength from about 1 μm to about 100 μm by from about 5% to about 50% of the wavelength.

26. The method of claim 16, wherein modifying the transmission of the optical transmission filter comprises switching the transmission spectrum in the infrared spectral region.

27. The method of claim 16, wherein modifying the transmission of the optical transmission filter comprises blocking transmission of a wavelength from about 1 μm to about 100 μm by up to 100%.

28. The method of claim 16, wherein modifying the transmission of the optical element comprises blocking transmission of a wavelength from about 1 μm to about 100 μm by from about 50% to about 99% of the wavelength.

29. The method of claim 16, wherein the metamaterial component comprises a metal patterned on a substrate to produce an array of split ring resonators.

30. The method of claim 16, wherein the metamaterial component comprises a substrate selected from the group consisting of p-doped diamond, GaAs, ZnS, Ge, SiGe, GaInP, AlGaAs, GaInAs, AlInGaP, GaAsN, GaN, GaInN, InN, GaInAlN, GaAlSb, GaInAlSb, CdTe, MgSe, MgS, 6HSiC, ZnTe, CgSe, GaAsSb, GaSb, InAsN, 4H—SiC, a-Sn, BN, BP, BAs, AlN, ZnO, ZnSe, CdSe, CdTe, HgS, HgSe, PbS, PbSe, PbTe, HgTe, HgCdTe, CdS, ZnSe, InSb, AlP, AlAs, AlSb, InAs, and AlSb.

31. The method of claim 16, wherein each of the second component comprises a metamaterial having metal patterned on a substrate to produce an array of split ring resonators.

32. The method of claim 31, wherein second component metamaterial comprises a substrate selected from the group consisting of p-doped diamond, GaAs, ZnS, Ge, SiGe, GaInP, AlGaAs, GaInAs, AlInGaP, GaAsN, GaN, GaInN, InN, GaInAlN, GaAlSb, GaInAlSb, CdTe, MgSe, MgS, 6HSiC, ZnTe, CgSe, GaAsSb, GaSb, InAsN, 4H—SiC, a-Sn, BN, BP, BAs, AlN, ZnO, ZnSe, CdSe, CdTe, HgS, HgSe, PbS, PbSe, PbTe, HgTe, HgCdTe, CdS, ZnSe, InSb, AlP, AlAs, AlSb, InAs, and AlSb.

33. The method of claim 16, wherein second component comprises a natural material selected from the group consisting of p-doped diamond, GaAs, ZnS, Ge, SiGe, GaInP, AlGaAs, GaInAs, AlInGaP, GaAsN, GaN, GaInN, InN, GaInAlN, GaAlSb, GaInAlSb, CdTe, MgSe, MgS, 6HSiC, ZnTe, CgSe, GaAsSb, GaSb, InAsN, 4H—SiC, a-Sn, BN, BP, BAs, AlN, ZnO, ZnSe, CdSe, CdTe, HgS, HgSe, PbS, PbSe, PbTe, HgTe, HgCdTe, CdS, ZnSe, InSb, AlP, AlAs, AlSb, InAs, and AlSb.

34. The method for making a tunable optical transmission filter comprising:
electromagnetically coupling a metamaterial component to a second component; and
operably connecting the metamaterial component and the second component with one or more micromechanical actuator capable of providing vertical actuation, lateral actuation, or combinations thereof of the metamaterial component relative to the second component.

35. The method of claim 34, wherein the second component is selected from the group consisting of a second metamaterial component and a natural material.

36. The method of claim 34, wherein the metamaterial component and the second component are separated by a distance of from about 5 nm to about 5000 nm.

37. The method of claim 34, wherein the each of the one or more micromechanical actuators is capable of vertically or laterally changing a position of the metamaterial component relative to the second component by about 5 nm to about 5000 nm.

38. An article of manufacture comprising an optical transmission filter having:
a first patterned metamaterial layer;
a material layer electromagnetically coupled to the first patterned metamaterial layer; and
one or more micromechanical actuator operably connecting the first patterned metamaterial layer and the second metamaterial layer, the one or more micromechanical actuator being capable of providing vertical actuation, lateral actuation, or combinations thereof of the first patterned metamaterial layer relative to the second metamaterial layer

39. The article of manufacture of claim 38, wherein the article is configured and arranged to be used for communications, thermal imaging, microscopy, spectroscopy, infrared imaging, thermal imaging, hyperspectral imaging, or chemical sensing.

40. The article of manufacture of claim 38, wherein the article is selected from aircraft, spacecraft, boats, automobiles, trucks, satellites, land based products, sea based products, consumer products, or combinations thereof.
